(19) United States
(12) Patent Application Publication
(10) Pub. No.: US 2022/0230413 A1
(43) Pub. Date: Jul. 21, 2022

(54) IMAGE SORTING METHOD, DEVICE, ELECTRONIC APPARATUS, AND STORAGE MEDIUM

(71) Applicant: Lenovo (Beijing) Limited, Beijing (CN)

(72) Inventors: Xinfeng CHANG, Beijing (CN); Hui LI, Beijing (CN); Qichuan YANG, Beijing (CN)

(21) Appl. No.: 17/548,891

(22) Filed: Dec. 13, 2021

(30) Foreign Application Priority Data
Jan. 21, 2021 (CN) 202110082059.X

(51) Int. Cl. G06V 10/764; G06V 10/40; G06V 10/22

(52) U.S. Cl. CPC G06V 10/764; G06V 10/22; G06V 10/40

(57) ABSTRACT

An image sorting method includes obtaining a plurality of images that need to be sorted, determining a feature identification area of an image, recognizing the content of the feature identification area of each of the images in sequence to obtain a feature content of the feature identification area of each of the images, and sorting the plurality of images based on the feature content of the feature identification area of each of the images. Content of the feature identification area is used to distinguish different images.

### CROSS-REFERENCE TO RELATED APPLICATION

This application claims priority to Chinese Patent Application No. 202110082059.X, filed on Jan. 21, 2021, the entire content of which is incorporated herein by reference.

### TECHNICAL FIELD

The present disclosure generally relates to the image processing technology field and, more particularly, to an image sorting method, a device, an electronic apparatus, and a storage medium.

### BACKGROUND

As electronic apparatus develops continuously, the electronic apparatus can obtain a plurality of images by photographing through a camera or using other methods. Currently, when an electronic apparatus stores and displays the plurality of images, the plurality of images are generally sorted according to the generation time of the plurality of images.

In daily life, a user often needs to process a large quantity of images of a same category. In this situation, the user may be more concerned about the content of the images rather than the generation time of the images. Therefore, sorting the images based on the generation time of the images does not enable the user to quickly and conveniently search and process the images.

### SUMMARY

Embodiments of the present disclosure provide an image sorting method. The method includes obtaining a plurality of images that need to be sorted, determining a feature identification area of an image, recognizing the content of the feature identification area of each of the images in sequence to obtain a feature content of the feature identification area of each of the images, and sorting the plurality of images based on the feature content of the feature identification area of each of the images. Content of the feature identification area is used to distinguish different images.

Embodiments of the present disclosure provide a computer storage medium. The computer storage medium stores computer program instructions, when executed by a processor, the computer program instructions implement the image sorting method. The image sorting method includes obtaining a plurality of images that need to be sorted, determining a feature identification area of an image, recognizing the content of the feature identification area of each of the images in sequence to obtain a feature content of the feature identification area of each of the images, and sorting the plurality of images based on the feature content of the feature identification area of each of the images. Content of the feature identification area is used to distinguish different images.

Embodiments of the present disclosure provide an image sorting device, including an image acquisition circuit, an identification area determination circuit, a content recognition circuit, and an image sorting circuit. The image acquisition circuit is configured to obtain a plurality of images that need to be sorted. The identification area determination circuit is configured to determine a feature identification area of an image. Content of the feature identification area is used to distinguish different images. The content recognition circuit is configured to recognize the content of the feature identification area of each of the images in sequence to obtain a feature content of the feature identification area of each of the images. The image sorting circuit is configured to sort the plurality of images based on the feature content of the feature identification area of each of the images.

Based on the above solution, after obtaining the plurality of images that need to be sorted, the method includes determining the feature identification area in the image. The content in the feature identification area can be used to distinguish different pictures. Thus, after sorting the plurality of images based on the feature content of the feature content based on the feature identification area of each image, the user may quickly search for the desired images from the plurality of images according to the feature content in the feature identification area. The image sorting may be more flexible. The user may search for the image from the plurality of images more conveniently.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic flowchart of an image sorting method according to some embodiments of the present disclosure.

FIG. 2 illustrates a schematic flowchart of an image sorting method according to some embodiments of the present disclosure.

FIG. 3 illustrates a schematic flowchart of an image sorting method according to some other embodiments of the present disclosure.

FIG. 4 illustrates a schematic flowchart of an image sorting method according to some other embodiments of the present disclosure.

FIG. 5 illustrates a schematic flowchart of an image sorting method according to some other embodiments of the present disclosure.

FIG. 6 illustrates a schematic flowchart of an image sorting method in an application scene according to some embodiments of the present disclosure.

FIG. 7 illustrates a schematic structural diagram of an image sorting device according to some embodiments of the present disclosure.

FIG. 8 illustrates a schematic structural diagram of an electronic apparatus according to some embodiments of the present disclosure.

### DETAILED DESCRIPTION OF THE EMBODIMENTS

The solution of the present disclosure is suitable for an electronic apparatus such as a cellphone, a laptop, a tablet computer, and a personal computer. A plurality of images of the electronic apparatus may be sorted more flexibly using the solution of the present disclosure, which is beneficial for a user to more conveniently and efficiently search and process the images based on the sorted images.

The terms “first,” “second,” “third,” “fourth,” etc. (if exist) in the specification, the claims, and the above-mentioned accompanying drawings are used to distinguish similar parts but not necessarily used to describe a specific order or sequence. It should be understood that the data used with these terms can be interchanged under appropriate situations. Thus, embodiments of the present disclosure described herein may be implemented in a sequence other than those illustrated here.

The technical solutions of embodiments of the present disclosure are described in detail below in connection with the accompanying drawings of embodiments of the present disclosure. Apparently, described embodiments are only some embodiments of the present disclosure rather than all embodiments. Based on embodiments of the present disclosure, all other embodiments obtained by those of ordinary skill in the art without creative work shall be within the scope of the present disclosure.

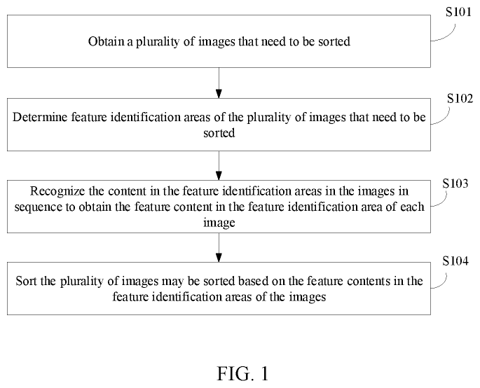

FIG. 1 illustrates a schematic flowchart of an image sorting method according to some embodiments of the present disclosure. The method of embodiments of the present disclosure includes the following processes.

At S101, a plurality of images that need to be sorted are obtained.

For example, the plurality of images that need to be sorted may include a plurality of images selected by the user. For example, a file selected by the user may include the plurality of images, or the user may select the plurality of images from an image storage area.

In practical applications, the plurality of images that need to be stored obtained by an electronic apparatus may be determined as the plurality of images that need to be sorted, which is not limited.

At S102, feature identification areas of the plurality of images that need to be sorted may be determined.

Content in the feature identification areas may be used to distinguish different images. Therefore, each of the plurality of images may be distinguished by the content in the feature identification areas.

In some embodiments, a feature identification area in an image may be an identification area designated or selected by the user. For example, the user may mark or select the feature identification area in any one of the plurality of images, such that the electronic apparatus may determine the location of the feature identification area of each image.

In some other embodiments, the feature identification area of the image may be fixed or predetermined. For example, when the image is an invoice image, since the invoice serial number may uniquely identify an invoice, the location area of the invoice serial number may be determined as the feature identification area of the image. Different object categories may correspond to different feature identification areas of the images.

In some embodiments, an object category shown in the image may be recognized. The object category may be used to represent the category of the object content shown in the image. For example, the image may be an invoice image, a test paper, or an article, etc., and then, the object category of the object in the image may be divided into categories, such as invoice, test paper, and article. Correspondingly, the feature identification area of the image may be determined based on the location information of the feature identification area corresponding to the object category of the image.

For example, still taking the invoice as an example, the invoice number may be generally at an upper right corner of the invoice. Therefore, a coordinate area corresponding to the upper right corner of the image of the invoice category may be set as the feature identification area of the invoice.

At S103, the content in the feature identification areas in the images may be recognized in sequence to obtain the feature content in the feature identification area of each image.

For example, optical character recognition (OCR) and another method may be used to recognize content such as characters in the feature identification area in the image.

To facilitate the distinction, the content recognized from the feature identification area of the image may be called the feature content.

At S104, the plurality of images may be sorted based on the feature content in the feature identification areas of the images.

In embodiments of the present disclosure, the plurality of images may be sorted based on the feature content of the images.

There may be a plurality of methods to sort the images by using the feature content as the sorting basis, which is not limited in the present disclosure.

For example, different sorting rules may be adopted according to different data forms of the feature content. For example, if the feature content includes a number, the plurality of images may be sorted based on the feature content corresponding to the images according to the sorting rule of numerical values in ascending order.

For another example, the plurality of images may be sorted according to a sorting rule that is predetermined or currently input or selected by the user in connection with the feature content in the feature identification areas of the images.

After the plurality of images are sorted based on the feature content, the feature content of neighboring images may be relatively similar or relevant. Based on this, the user may quickly search the image with the required feature content according to the feature content of the image.

For example, the image of the student test paper may be taken as an example. The student number area in the image of the test paper may be used as the feature identification area. In this situation, the student number in the feature identification area of each test paper may be recognized. Based on this, the images may be sorted according to the student numbers in the images of the test papers so that the user, e.g. a teacher, can see the test papers sorted according to the student numbers. As such, the user can record the results of the students according to the student numbers or perform another related processing on the test papers according to the student numbers.

In the present disclosure, after obtaining the plurality of images, the method may include determining the feature identification areas of the images. The content in the feature identification areas may be used to distinguish different images. Thus, the user may quickly search the needed image from the plurality of images according to the feature content of the feature identification area after the plurality of images are sorted based on the feature content of the feature identification areas of the images. Therefore, the images may be sorted flexibly, and the convenience of searching for an image from the plurality of images may be improved.

To facilitate understanding, a method of determining the feature identification area in the image is taken as an example to describe the solution of the present disclosure.

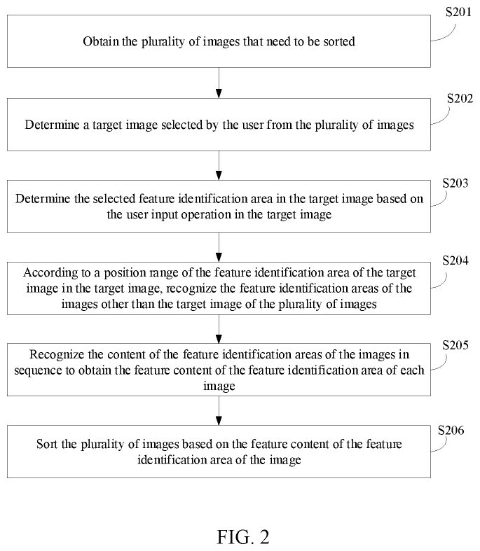

FIG. 2 illustrates a schematic flowchart of an image sorting method according to some embodiments of the present disclosure. The method of embodiments of the present disclosure includes the following processes.

At S201, the plurality of images that need to be sorted are obtained.

At S202, a target image selected by the user is determined from the plurality of images.

The target image may include any one of the plurality of images. The user may select one of the plurality of images pictures as needed to perform a subsequent operation of marking the feature identification area in the image.

For example, the user may click one image of the plurality of images, and then, the electronic apparatus may determine the image as the target image.

At S203, the selected feature identification area in the target image is determined based on the user input operation in the target image.

In embodiments of the present disclosure, the user input operation of selecting the feature identification area in the target image may include a plurality of methods.

For example, the user may circle the area in the target image as the sorting basis. Accordingly, the electronic apparatus may determine the selected circled area in the target image according to a movement trajectory of touchpoints or a cursor and use this area as the feature identification area.

For example, the target image may be the test paper. If the user wants to use the student number on the test paper as the sorting basis for the test paper, the user can select the area of the student number on the image of the test paper. Then, the electronic apparatus may recognize the area selected by the user to determine the area of the student number as the feature identification area.

For another example, the electronic apparatus may recognize optional areas included in the target image and use a dashed circle or other forms to mark the optional areas. Based on this, the user input operation may include a selection operation of selecting the target area from a plurality of optional areas. For example, if the user clicks on an optional area, correspondingly, the electronic apparatus may use the target area selected by the user as the feature identification area.

In practical applications, the user may select the feature identification area in another method, which is not limited in the present disclosure.

At S204, according to a position range of the feature identification area of the target image in the target image, the feature identification areas of the images other than the target image of the plurality of images may be recognized.

In the present disclosure, the plurality of images may be images of a same category. Based on this, when the feature identification area of any one of the plurality of images is determined, the electronic apparatus may recognize the feature identification areas of other images according to the position range of the feature identification area in the image.

For example, in embodiments of the present disclosure, after obtaining the plurality of images, the method may include determining an area distribution pattern corresponding to the plurality of images. The area distribution pattern may include components of the images. Based on this, after determining the feature identification area of the target image, the method may include determining the position range of the feature identification area in the area distribution pattern and then matching the feature identification areas corresponding to the position range in the images according to the position range of the area distribution pattern.

In embodiments of the present disclosure, the user may select an image and select a feature identification area in the image. Based on this, the feature identification area of the image may be used as a basis for determining a feature identification area of another image. Thus, the user does not need to separately select a feature identification area of each image, which is beneficial to reduce user operations and reduce the complexity of the user setting the image sorting method.

At S205, the content of the feature identification areas of the images are recognized in sequence to obtain the feature content of the feature identification area of each image.

Process S205 may be the same as the previous method of recognizing the content of the feature identification area of the image and is not repeated here.

In embodiments of the present disclosure, after determining a feature identification area of an image in process S204, the method may include directly recognizing a picture in the feature identification area of the image. Process S205 may be performed without waiting to determine the feature identification areas of all the images.

At S206, the plurality of images may be sorted based on the feature content of the feature identification area of the image.

In embodiments of the present disclosure, the user may select the feature identification area as the sorting basis in the image as needed. Based on this, sorting the plurality of images in connection with the content of the feature identification areas of the images may realize sorting the images according to user sorting requirements. Thus, the image may be sorted according to the user requirements, which improves the flexibility of the image sorting. Based on this, since the plurality of images are sorted according to the feature content of the feature identification areas of the images, the images with similar feature content of the feature identification areas may be close by. Thus, the user can conveniently and efficiently search for the desired image.

Another method of determining the feature identification area in the image may be taken as an example to describe the solution of the present disclosure below.

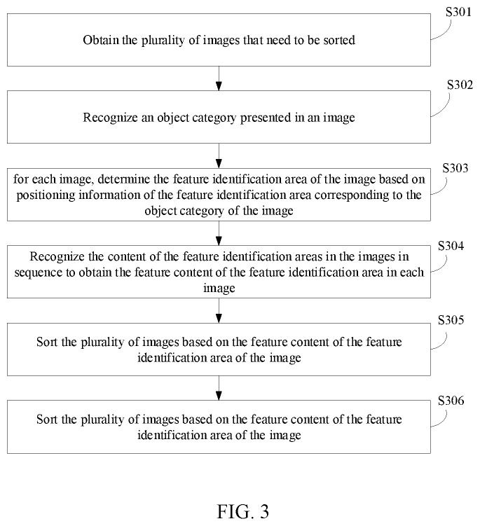

FIG. 3 illustrates a schematic flowchart of an image sorting method according to some other embodiments of the present disclosure. The method of embodiments of the present disclosure includes the following processes.

At S301, the plurality of images that need to be sorted are obtained.

At S302, an object category presented in an image is recognized.

The object category may represent the category of the object content displayed in the picture. For example, the object category may include a test paper, an invoice, a certificate, a contract, or other object categories.

For images of objects of different categories, the content for distinguishing different images and the position areas of the content may be also different. For example, an image of a contract may need a contract number of the contract to distinguish images of different contracts. An image of a test paper may use a candidate name, a candidate number, or a student number on the test paper to distinguish images of different test papers. Based on this, to be able to determine the content according to which the image is sorted, the object category of the object in the image needs to be recognized first.

The plurality of images that need to be sorted of embodiments of the present disclosure may be generally a plurality of images of the same object category. In this situation, the electronic apparatus can select one randomly, or the user can specify an image of the to-be-recognized object category. The electronic apparatus may only need to recognize the object content of the image.

If the plurality of images may include a plurality of images with different object categories, in this situation, the electronic apparatus may also classify the plurality of images according to the content arrangement of the content in the images first. Each image category may include at least one image. Correspondingly, for each image category, one image of the image category may be selected to recognize an object category presented by the image category.

For the other methods of determining the feature identification area mentioned above, if not all the plurality of images belong to the same image category, the images may also be classified first, and then, the feature identification area of the image category may be determined separately for each image category.

At S303, for each image, the feature identification area of the image is determined based on positioning information of the feature identification area corresponding to the object category of the image.

For example, the position information of the feature identification areas corresponding to different object categories can be pre-configured. Based on this, the positioning information of the feature identification area suitable for the image may be obtained based on a predetermined correspondence between the object category and the positioning information of the feature identification area.

The positioning information of the feature identification area may be information used to determine a coordinate range or an area label of the feature identification area in the image, which is not limited.

At S304, the content of the feature identification areas in the images are recognized in sequence to obtain the feature content of the feature identification area in each image.

At S305, the plurality of images are sorted based on the feature content of the feature identification area of the image.

For processes S304 and S305, reference may be made to the related description of embodiments of the present disclosure, which is not repeated here.

The solution of the present disclosure is described blow according to different sorting methods for sorting the plurality of images.

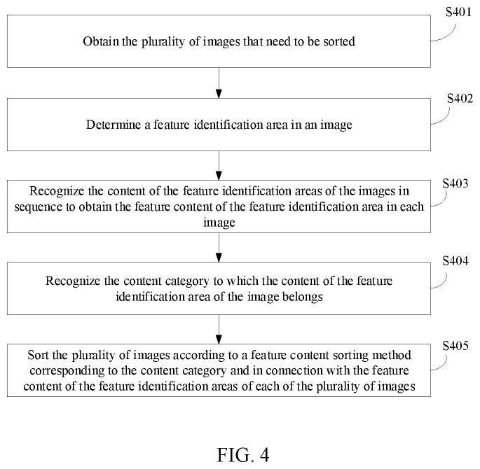

FIG. 4 illustrates a schematic flowchart of an image sorting method according to some other embodiments of the present disclosure. The method of embodiments of the present disclosure includes the following processes.

At S401, the plurality of images that need to be sorted are obtained.

At S402, a feature identification area in an image is determined.

At S403, the content of the feature identification areas of the images are recognized in sequence to obtain the feature content of the feature identification area in each image.

For the above processes, reference may be made to the relevant description of any of the above embodiments, which is not repeated here.

At S404, the content category to which the content of the feature identification area of the image belongs is recognized.

The content category may represent a data expression form of the content of the feature identification area.

For example, the content category may include a plurality of forms such as a number, a Chinese character, or an English letter.

When the plurality of images targeted for sorting are images of the same object category, the process may only need to include recognizing the content category for any one image and may not need to include performing this operation for each image.

If the plurality of images include images of a plurality of object categories, after the plurality of images are classified, for the images of each category, only the content category of the feature identification area in an image may need to be recognized in the category.

At S405, the plurality of images are sorted according to a feature content sorting method corresponding to the content category and in connection with the feature content of the feature identification areas of each of the plurality of images.

Different feature content sorting methods may be applied to different content categories. In some embodiments, the user may pre-configure the feature content sorting methods suitable for different content categories, or the electronic apparatus may set the sorting methods corresponding to different content categories.

For example, if the content category includes numbers, the sorting method may include sorting the images according to the values of the numbers in ascending order or according to the values in descending order.

For another example, the content category may include Chinese characters. The sorting method may include sorting the images according to an alphabet order of first letter of pinyin.

When the plurality of images are classified into a plurality of categories, in the present disclosure, the method may further include sequentially sorting separately for each category. The sorting method of each category may be the same. That is, after the content categories of the feature identification areas of images in the category, the images in the category may be sorted in connection with the content of the feature identification areas of the images in the category

In the present disclosure, after the content in the feature identification areas of the images are determined, a suitable feature content sorting method may be determined. Thus, the plurality of images may be sorted according to the feature content sorting method. Therefore, the images may be automatically sorted without user interference, which reduces the complexity of the picture sorting.

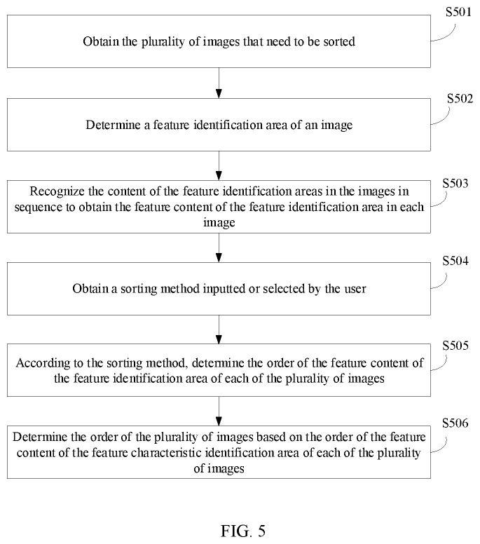

Another sorting method for sorting the plurality of images may be taken as an example to describe the solution of the present disclosure. FIG. 5 illustrates a schematic flowchart of an image sorting method according to some other embodiments of the present disclosure. The method of embodiments of the present disclosure includes the following processes.

At S501, the plurality of images that need to be sorted are obtained.

At S502, a feature identification area of an image is determined.

At S503, the content of the feature identification areas in the images are recognized in sequence to obtain the feature content of the feature identification area in each image.

For the above processes, reference may be made to the related description of the above embodiments, which is not be repeated here.

At S504, a sorting method inputted or selected by the user is obtained.

For example, after the content of the feature identification areas of the images are recognized, a sorting setting column may be output. In the sorting setting column, a plurality of optional sorting methods corresponding to the content of the feature identification areas may be displayed for the user to select the sorting method. Alternatively, the sorting setting column may include a sorting input box, and the user may input a desired sorting method in the sorting input box.

The image of the test paper may be taken as an example. Assume that the content in the feature identification area of the test paper includes numbers, the optional sorting method, which may include value ascending and value descending, corresponding to the numbers may be output. Correspondingly, the user may select a sorting method so that the electronic apparatus may obtain the sorting method input by the user.

At S505, according to the sorting method, the order of the feature content of the feature identification area of each of the plurality of images is determined.

At S506, the order of the plurality of images is determined based on the order of the feature content of the feature characteristic identification area of each of the plurality of images.

Since the content of the feature identification area of the image may include information that distinguishes between different images, based on this, after the order of the feature content of the feature identification areas are determined, the order of multiple pictures can be determined according to the order.

For example, the content is the student number of the test paper. After the order of each student number is determined, the order of each student number may be the corresponding order of the image of the test paper to which each student number belongs. Therefore, then according to the order of the student number and the corresponding image of the test paper of each student number, the order of the image of the test paper may be determined.

In embodiments of the present disclosure, the user can set the sorting method as needed so that the order of the plurality of images according to the sorting method may facilitate the user to search and process the images.

The order of the plurality of images involved in the solution of the present disclosure may include the order of the images including the same content, for example, the order of the plurality of images of test papers, and the order of the plurality of images of invoices. If the plurality of images include images of a plurality of object categories, the images of each category may be sorted separately.

In practical applications, the user may pay more attention to the order of the images of a same object category. Therefore, the plurality of images that need to be sorted obtained in the present disclosure may include the images of the same object category. In this situation, after obtaining the plurality of images, the method of the present disclosure may further include detecting whether the plurality of images are the images of the same object category.

In some embodiments, after the plurality of images are obtained in the present disclosure, the method of the present disclosure may further include determining whether content modules of the plurality of images and an arrangement of the content modules are the same. The image may include the content of at least one content module. For example, when the image is a test paper, the test paper may be divided into a header and a plurality of test question parts, etc., whether each of the plurality of image includes the header and the plurality of test question parts and whether the arrangement of the parts is the same may be detected.

Correspondingly, if the content modules and the arrangement of the content modules of the plurality of images are not the same, it means that the plurality of images include images of different object categories. In this situation, the method may include outputting a prompt to the user. The prompt may be used to remind the user that the plurality of images of different categories may exist. Thus, the user can eliminate the images of different categories or reselect images that need to be sorted.

To facilitate the understanding of the advantages of the present disclosure, the following description is combined with an application scene. The scene where the user needs to sort the plurality of test papers is taken as an example.

Assume that after the teacher obtains a plurality of images through a scanner or photographing, the images of the plurality of test papers may be usually out of order. However, if the images is only sorted based on the generation time of the images, then if the teacher needs to search for a test paper for a certain student, the teacher may need to look through the image of each of the test papers in sequence, which is more complicated and time-consuming.

In some embodiments, as shown in FIG. 6, the sorting method is implemented for this scene. FIG. 6 illustrates a schematic flowchart of an image sorting method in an application scene according to some embodiments of the present disclosure. The method of embodiments of the present disclosure includes the following processes.

At S601, the plurality of to-be-sorted test paper images are obtained.

For example, the plurality of test paper images transmitted by a scanner may be obtained, which is not limited here.

At S602, a feature identification area selected by the user in a target test paper image of the plurality of test paper images is obtained.

In some embodiments, the user is the teacher. Assume that the teacher selects any one of the plurality of images and encloses an area of the test paper where a student number is in the image. Correspondingly, the electronic apparatus may determine the area where the student number is enclosed by the teacher as a feature identification area of the test paper image.

At S603, based on the feature identification area selected in the target test paper image, the feature identification areas of the test paper images are determined in sequence, and the student numbers in the feature identification areas are recognized by an OCR.

The plurality of images include images of the same test paper of different students. Thus, after the student number area of one test paper image is determined, the electronic apparatus may match a student number area of each of the test paper images according to a position of the student number area in the test paper image. The electronic apparatus may then recognize the student number corresponding to each of the test paper images.

At S604, the plurality of test paper images are sorted according to the ascending order of the recognized student numbers of the test paper images in ascending order.

In some embodiments, for example, by default, the student numbers may be sorted in ascending order. In practical applications, the teacher may also select or input the sorting method of the student numbers as needed.

The test paper images may be sorted in ascending order, which may prevent the teacher from manually sorting the test papers. Thus, the teacher may easily search the test paper of a certain student number or register the scores of the test papers in order of the student number. The convenience of image operation may be improved.

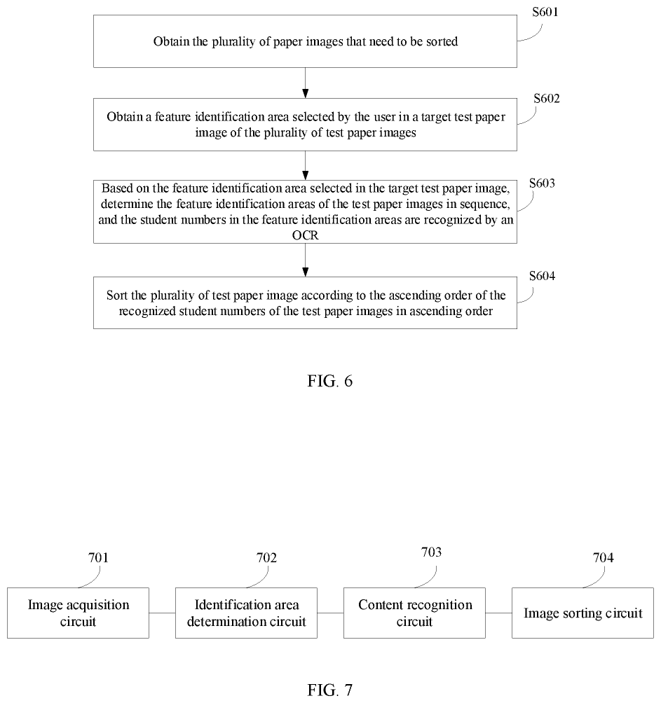

Corresponding to an image sorting method of the present disclosure, the present disclosure further provides an image sorting device. FIG. 7 illustrates a schematic structural diagram of an image sorting device according to some embodiments of the present disclosure. The device includes an image acquisition circuit 701, an identification area determination circuit 702, a content recognition circuit 703, and an image sorting circuit 704. The image acquisition circuit 701 may be configured to obtain the plurality of images that need to be sorted. The identification area determination circuit 702 may be configured to determine a feature identification area in the image. The content of the feature identification area may be used to distinguish different pictures. The content recognition circuit 703 may be configured to sequentially recognize the content of the characteristic identification areas in the images and obtain the feature content of the characteristic identification area in each image. The image sorting circuit 704 may be configured to sort the plurality of images based on the feature content of the feature identification areas of the images.

In some embodiments, the device further includes a content category determination circuit. The content category determination circuit may be configured to recognize the content category to which the content of the feature identification area of the image belongs before the image sorting circuit sorts the plurality of images. The content category may represent data representation form of the content of the feature identification area.

The image sorting circuit includes a first image sorting circuit. The first image sorting circuit may be configured to sort the plurality of images according to the feature content sorting method corresponding to the content category and in connection with the feature content in the feature identification areas of the plurality of images.

In some other embodiments, the image sorting circuit includes a method acquisition circuit, a content sorting circuit, and a second image sorting circuit. The method acquisition circuit may be configured to obtain a sorting method input or selected by the user. The content sorting circuit may be configured to determine an order of the feature content of the feature identification area of each of the plurality of images according to the sorting method. The second picture sorting circuit may be configured to determine an order of the plurality of images based on the order of the feature content of the feature identification area of each of the plurality of images.

In some embodiments, the identification area determination circuit includes an image selection circuit, a first area determination circuit, and an area recognition circuit. The image selection circuit may be configured to determine the target image selected by the user from the plurality of images. The first area determination circuit may be configured to determine the selected feature identification area in the target image based on a user input operation on the target image. The area recognition circuit may be configured to recognize feature identification areas of images other than the target image in the plurality of images according to the position range of the feature identification area of the target image in the target picture.

In some other embodiments, the identification area determination circuit includes a category recognition circuit and a second area determination circuit. The category recognition circuit may be configured to recognize the object category presented in the image. The object category may represent the category of the object content shown in the image. The second area determination circuit may be configured to determine the feature identification area in the image based on the positioning information of the feature identification area corresponding to the object category of the image.

In some other embodiments, the device further includes a detection circuit and a prompt output circuit. The detection circuit may be configured to determine whether the content modules of the plurality of images and the arrangement of the content modules are the same after the image acquisition circuit obtains the plurality of images that need to be sorted. The image may include the content of at least one content module. The prompt output circuit may be configured to output a prompt to the user if the content modules and the arrangement of the content modules of the plurality of images are not the same. The prompt may be used to prompt the user that a plurality of images of different categories may exist.

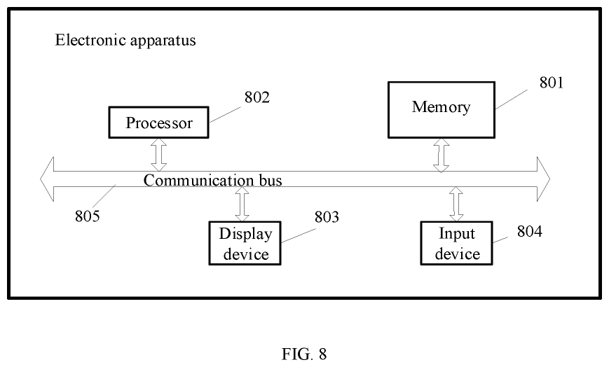

In another aspect, the present disclosure further provides an electronic apparatus. FIG. 8 illustrates a schematic structural diagram of an electronic apparatus according to some embodiments of the present disclosure. The electronic apparatus may include a server of an interactive system or a client terminal of the interactive system. The electronic apparatus includes at least a memory 801 and a processor 802. The processor 801 may be configured to execute the image sorting method of embodiments of the present disclosure. The memory is used to store programs required by the processor to perform operations.

The electronic apparatus further includes a display device 803, an input device 804, and a communication bus 805. The electronic apparatus may also include more or less components than those shown in FIG. 8, which is not limited here.

On another aspect, the present disclosure further provides a computer-readable storage medium. The computer-readable storage medium stores at least one instruction, at least one segment of a program, a code set, or an instruction set. The at least one instruction, the at least one section of the program, the code set, or the instruction set may be loaded and executed by the processor to implement the image sorting method of embodiments of the present disclosure.

The present disclosure further provides a computer program. The computer program may include computer instructions. The computer instructions may be stored in the computer-readable storage medium. When the computer program runs on the electronic apparatus, the electronic apparatus may be caused to execute the image sorting method of embodiments of the present disclosure.

Embodiments in this specification are described in a progressive manner. Each embodiment focuses on the differences from other embodiments. The same and similar parts between embodiments may be referred to each other. Meanwhile, the features described in embodiments of this specification may be replaced or combined with each other, so that those skilled in the art can implement or use the present disclosure. Since device embodiments are similar to method embodiments, the description is relatively simple. For related parts, reference may be made to the part of the description of method embodiments.

The description of disclosed embodiments may enable those skilled in the art to implement or use the present disclosure. Various modifications of embodiments are obvious to those skilled in the art. The general principles defined in the specification may be implemented in other embodiments without departing from the spirit or scope of the present disclosure. Therefore, the present disclosure is not be limited to embodiments shown in the specification, but should conform to the widest scope consistent with the principles and novel features of the present disclosure.

What is claimed is:

1. An image sorting method comprising:
obtaining a plurality of images that need to be sorted;
determining a feature identification area of an image, content of the feature identification area being used to distinguish different images;
recognizing the content of the feature identification area of each of the images in sequence to obtain a feature content of the feature identification area of each of the images; and
sorting the plurality of images based on the feature content of the feature identification area of each of the images.

2. The method of claim 1, further comprising, before sorting the plurality of images based on the feature content of the feature identification area of each of the images:
recognizing a content category, to which the content of the feature identification area of the image belongs, the content category representing a data representation form of the content of the feature identification area;
wherein sorting the plurality of images based on the feature content of the feature identification area of each of the images includes:
sorting the plurality of images according to a sorting method of a plurality of feature content corresponding to the feature category and in connection with the feature content of the feature identification area of each of the plurality of images.

3. The method of claim 1, wherein sorting the plurality of images based on the feature content of the feature identification area of each of the images includes:
obtaining a sorting method selected by a user;
according to the sorting method, determining an order of a feature content of the feature identification area of each of the plurality of images; and
determining an order of the plurality of images based on the order of the feature content of the feature identification area of each of the plurality of images.

4. The method of claim 1, wherein determining the feature identification area of the image includes:
determining a target image selected by a user from the plurality of images;
determining the selected feature identification area in the target image based on an input operation of the user on the target image; and
recognizing feature identification areas of images other than the target image in the plurality of images according to a position range of the feature identification area of the target image in the target image.

5. The method of claim 1, wherein determining the feature identification area of the image includes:
recognizing an object category shown in the image, the object category representing a category of an object content shown in the image; and
determining the feature identification area of the image based on positioning information of the feature identification area corresponding of the object category of the image.

6. The method of claim 1, further comprising, after obtaining the plurality of images that need to be sorted:
determining whether content modules and arrangements of content modules of the plurality of images are same, an image including content of at least one content module; and
in response to the content modules and the arrangements of the content modules of the plurality of images are not same, outputting a prompt to a user, the prompt being used to remind the user that images of different categories exist.

7. A computer storage medium storing computer program instructions, when executed by a processor, the computer program instructions implementing the image sorting method comprising:
obtaining a plurality of images that need to be sorted;
determining a feature identification area of an image, content of the feature identification area being used to distinguish different images;
recognizing the content of the feature identification area of each of the images in sequence to obtain a feature content of the feature identification area of each of the images; and
sorting the plurality of images based on the feature content of the feature identification area of each of the images.

8. The computer storage medium of claim 7, wherein the image sorting method further includes, before sorting the plurality of images based on the feature content of the feature identification area of each of the images:
recognizing a content category, to which the content of the feature identification area of the image belongs, the content category representing a data representation form of the content of the feature identification area;
wherein sorting the plurality of images based on the feature content of the feature identification area of each of the images includes:
sorting the plurality of images according to a sorting method of a plurality of feature content corresponding to the feature category and in connection with the feature content of the feature identification area of each of the plurality of images.

9. The computer storage medium of claim 7, wherein sorting the plurality of images based on the feature content of the feature identification area of each of the images includes:
obtaining a sorting method selected by a user;
according to the sorting method, determining an order of a feature content of the feature identification area of each of the plurality of images; and
determining an order of the plurality of images based on the order of the feature content of the feature identification area of each of the plurality of images.

10. The computer storage medium of claim 7, wherein determining the feature identification area of the image includes:
determining a target image selected by a user from the plurality of images;
determining the selected feature identification area in the target image based on an input operation of the user on the target image; and
recognizing feature identification areas of images other than the target image in the plurality of images according to a position range of the feature identification area of the target image in the target image.

11. The computer storage medium of claim 7, wherein determining the feature identification area of the image includes:
recognizing an object category shown in the image, the object category representing a category of an object content shown in the image; and
determining the feature identification area of the image based on positioning information of the feature identification area corresponding of the object category of the image.

12. The computer storage medium of claim 7, wherein the image sorting method further includes, after obtaining the plurality of images that need to be sorted:
determining whether content modules and arrangements of content modules of the plurality of images are same, an image including content of at least one content module; and
in response to the content modules and the arrangements of the content modules of the plurality of images are not same, outputting a prompt to a user, the prompt being used to remind the user that images of different categories exist.

13. An image sorting device comprising:
an image acquisition circuit configured to obtain a plurality of images that need to be sorted;
an identification area determination circuit configured to determine a feature identification area of an image, content of the feature identification area being used to distinguish different images;
a content recognition circuit configured to recognize the content of the feature identification area of each of the images in sequence to obtain a feature content of the feature identification area of each of the images; and
an image sorting circuit configured to sort the plurality of images based on the feature content of the feature identification area of each of the images.

14. The device of claim 13, further comprising:
a content category determination circuit configured to, before the image sorting circuit sorts the plurality of images, recognize a content category, to which the content of the feature identification area of the image belongs, the content category representing a data representation form of the content of the feature identification area;
wherein the image sorting circuit includes:
a first image sorting circuit configured to sort the plurality of images according to a sorting method of a plurality of feature content corresponding to the feature category and in connection with the feature content of the feature identification area of each of the plurality of images.

15. The device of claim 13, wherein the image sorting circuit includes:
a method acquisition circuit configured to obtain a sorting method selected by a user;
a content sorting circuit configured to, according to the sorting method, determine an order of a feature content of the feature identification area of each of the plurality of images; and
a second image sorting circuit configured to determine an order of the plurality of images based on the order of the feature content of the feature identification area of each of the plurality of images.

16. The device of claim 13, wherein the identification area determination circuit includes:
an image selection circuit configured to determine a target image selected by a user from the plurality of images;
a first area determination circuit configured to determine the selected feature identification area in the target image based on an input operation of the user on the target image; and
an area recognition circuit configured to recognize feature identification areas of images other than the target image in the plurality of images according to a position range of the feature identification area of the target image in the target image.

17. The device of claim 13, wherein the identification area determination circuit includes:
a category recognition circuit configured to recognize an object category shown in the image, the object category representing a category of an object content shown in the image; and
a second area determination circuit configured to determine the feature identification area of the image based on positioning information of the feature identification area corresponding of the object category of the image.

18. The device of claim 13, further comprising, after the image acquisition circuit obtains the plurality of images that need to be sorted:
a detection circuit configured to determine whether content modules and arrangements of content modules of the plurality of images are same, an image including content of at least one content module; and
a prompt output circuit configured to, in response to the content modules and the arrangements of the content modules of the plurality of images are not same, output a prompt to a user, the prompt being used to remind the user that images of different categories exist.
